(19) United States
(12) Patent Application Publication
(10) Pub. No.: US 2025/0292395 A1
(43) Pub. Date: Sep. 18, 2025

(54) INSPECTION ASSISTANCE DEVICE, INSPECTION ASSISTANCE METHOD, AND RECORDING MEDIUM

(71) Applicant: Evident Corporation, Kamiina-gun (JP)

(72) Inventors: Tsuyoshi FURUHATA, Kamiina-gun (JP); Takuma DEZAWA, Kamiina-gun (JP)

(73) Assignee: Evident Corporation, Kamiina-gun (JP)

(21) Appl. No.: 18/976,669

(22) Filed: Dec. 11, 2024

(30) Foreign Application Priority Data
Mar. 12, 2024 (JP) 2024-038074

(51) Int. Cl. G06T 7/00; H04N 23/50

(52) U.S. Cl. CPC G06T 7/001; H04N 23/555; G06T 2207/10068

(57) ABSTRACT

An inspection assistance device includes a processor. The processor connects to a storage medium that stores inspection requirement information indicating an inspection requirement determined in advance for each inspection target and acquires the inspection requirement information from the storage medium. The processor acquires inspection state information indicating an inspection state by confirming a state of an inspection device used to inspect the inspection target. The processor compares the inspection requirement information with the inspection state information and generates comparison result information indicating a comparison result. The processor outputs the comparison result information.

### BACKGROUND OF THE INVENTION

### Field of the Invention

The present invention relates to an inspection assistance device, an inspection assistance method, and a recording medium.

Priority is claimed on Japanese Patent Application No. 2024-038074, filed on Mar. 12, 2024, the content of which is incorporated herein by reference.

### Description of Related Art

Industrial endoscope devices are used to inspect internal abnormalities and corrosion in boilers, pipes, airplane engines, and the like. A user uses an endoscope device to inspect an inspection portion within an inspection target. The user confirms whether an abnormality such as a flaw has occurred in the inspection portion during the inspection. In order to leave evidence of the inspection, an image (a still image or a video) of the inspection portion is recorded. In a case in which an abnormality is found, information indicating the type of abnormality and the state of the abnormality is also recorded.

The inspection target includes a great number of inspection portions, and the type of abnormality and the state of the abnormality vary depending on the inspection portion. Therefore, an inspector needs knowledge or skills regarding the viewpoint of the inspection, the likelihood of an abnormality occurring in each inspection portion, and the like. For example, in a case in which inspection is performed by an inspector with little experience, an abnormality may be overlooked.

A technique disclosed in Japanese Patent No. 6947523 involves confirming the inspection history including inspection results showing abnormalities in the inspection target and involves warning the inspector when the amount of the inspection results showing abnormalities exceeds a threshold. A technique disclosed in Japanese Unexamined Patent Application, First Publication No. 2023-039392 involves displaying past inspection results before live images are acquired.

### SUMMARY OF THE INVENTION

According to an aspect of the present invention, an inspection assistance device includes a processor. The processor is configured to connect to a storage medium that stores inspection requirement information indicating an inspection requirement determined in advance for each inspection target and acquire the inspection requirement information from the storage medium. The processor is configured to acquire inspection state information indicating an inspection state by confirming a state of an inspection device used to inspect the inspection target. The processor is configured to compare the inspection requirement information with the inspection state information. The processor is configured to generate comparison result information indicating a result of comparing the inspection requirement information with the inspection state information and output the comparison result information.

In the inspection assistance device according to the aspect of the present invention, the inspection target may include an inspection portion. When inspection portion information indicating the inspection portion is accepted, the processor may compare the inspection requirement information with the inspection state information.

In the inspection assistance device according to the aspect of the present invention, the inspection target may include an inspection portion. When a folder associated with the inspection portion is set, the processor may compare the inspection requirement information with the inspection state information.

In the inspection assistance device according to the aspect of the present invention, the inspection target may include a first inspection portion and a second inspection portion. When a first folder associated with the first inspection portion is set and then a second folder associated with the second inspection portion is set instead of the first folder, the processor may compare the inspection requirement information with the inspection state information.

In the inspection assistance device according to the aspect of the present invention, when a user designates the inspection requirement information, the inspection requirement information designated by the user may be stored on the storage medium.

In the inspection assistance device according to the aspect of the present invention, the inspection requirement information may indicate that it is necessary to acquire position information indicating a position at which the inspection is to be performed. The processor may acquire information indicating whether the inspection assistance device is capable of acquiring the position information as the inspection state information.

In the inspection assistance device according to the aspect of the present invention, the inspection requirement information may indicate a state of an instrument used in the inspection device. The processor may acquire device information indicating the state of the instrument as the inspection state information.

In the inspection assistance device according to the aspect of the present invention, the inspection device may include an endoscope device having an insertion unit with an image sensor disposed at a distal end of the insertion unit. The inspection requirement information may indicate a type of optical adaptor attached to the distal end. The processor may acquire the device information indicating the type of optical adaptor.

In the inspection assistance device according to the aspect of the present invention, the type of optical adaptor may correspond to the optical adaptor used when measurement is executed.

In the inspection assistance device according to the aspect of the present invention, the inspection device may include an endoscope device having an insertion unit with an image sensor disposed at a distal end of the insertion unit. The inspection requirement information may indicate a type of insertion unit. The processor may acquire the device information indicating the type of insertion unit.

In the inspection assistance device according to the aspect of the present invention, when the device information is acquired, the processor may compare the inspection requirement information with the inspection state information.

In the inspection assistance device according to the aspect of the present invention, the inspection device may include an endoscope device having an insertion unit with an image sensor disposed at a distal end of the insertion unit.

In the inspection assistance device according to the aspect of the present invention, the inspection device may include an auxiliary device connected to the endoscope device or the inspection target.

In the inspection assistance device according to the aspect of the present invention, the storage medium may store two or more pieces of the inspection requirement information. The processor may acquire the two or more pieces of the inspection requirement information from the storage medium and may acquire two or more pieces of the inspection state information. The processor may compare each of the two or more pieces of the inspection requirement information with each of the two or more pieces of the inspection state information.

In the inspection assistance device according to the aspect of the present invention, the processor may output the comparison result information to a display.

In the inspection assistance device according to the aspect of the present invention, the comparison result information may include the inspection requirement information or the inspection state information.

According to an aspect of the present invention, an inspection assistance method includes the following processing. A processor connects to a storage medium that stores inspection requirement information indicating an inspection requirement determined in advance for each inspection target and acquires the inspection requirement information from the storage medium. The processor acquires inspection state information indicating an inspection state by confirming a state of an inspection device used to inspect the inspection target. The processor compares the inspection requirement information with the inspection state information. The processor generates comparison result information indicating a result of comparing the inspection requirement information with the inspection state information and outputs the comparison result information.

According to an aspect of the present invention, a computer readable non-transitory recording medium having a program recorded therein is provided, the program causing a computer to execute the following processes. The computer connects to a storage medium that stores inspection requirement information indicating an inspection requirement determined in advance for each inspection target, and acquires the inspection requirement information from the storage medium. The computer acquires inspection state information indicating an inspection state by confirming a state of an inspection device used to inspect the inspection target. The computer compares the inspection requirement information with the inspection state information. The computer generates comparison result information indicating a result of comparing the inspection requirement information with the inspection state information, and outputs the comparison result information.

### BRIEF DESCRIPTION OF THE DRAWINGS

FIG. 1 is a diagram showing a configuration of an inspection system according to a first embodiment of the present invention.

FIG. 2 is a perspective view of an endoscope device according to the first embodiment of the present invention.

FIG. 3 is a block diagram showing a configuration of the endoscope device and a server according to the first embodiment of the present invention.

FIG. 4 is a flowchart showing a procedure of inspection-requirement-setting processing in the first embodiment of the present invention.

FIG. 5 is a diagram showing an example of an input screen displayed on a display unit of the server according to the first embodiment of the present invention.

FIG. 6 is a diagram showing an example of an inspection folder in the first embodiment of the present invention.

FIG. 7 is a diagram showing an example of the inspection folder in the first embodiment of the present invention.

FIG. 8 is a flowchart showing a procedure of inspection assistance processing in the first embodiment of the present invention.

FIG. 9 is a diagram showing an example of comparison result information in the first embodiment of the present invention.

FIG. 10 is a diagram showing an example of the comparison result information in the first embodiment of the present invention.

FIG. 11 is a diagram showing an example of the comparison result information in the first embodiment of the present invention.

FIG. 12 is a diagram showing a configuration of an inspection system according to a second embodiment of the present invention.

FIG. 13 is a block diagram showing a configuration of a tablet terminal according to the second embodiment of the present invention.

### DETAILED DESCRIPTION OF THE INVENTION

Hereinafter, embodiments of the present invention will be described with reference to the drawings. An inspection target in each embodiment of the present invention is an industrial product. The inspection target has one or more inspection portions. For example, in a case in which the inspection target is an airplane engine, the inspection portion is a combustion tube, a high-pressure turbine, or the like. The inspection portion may be the entirety of the inspection target. For example, an abnormarity is a flaw. For example, the flaw is a crack, a dent, or a chip.

### First Embodiment

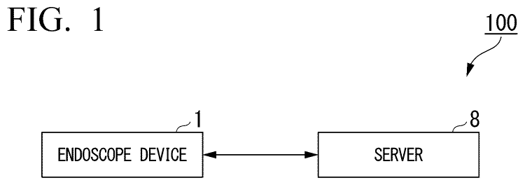

A first embodiment of the present invention will be described. FIG. 1 shows a configuration of an inspection system 100 according to the first embodiment. The inspection system 100 shown in FIG. 1 includes an endoscope device 1 and a server 8. The endoscope device 1 and the server 8 communicate with each other. The endoscope device 1 is an inspection device. For example, the server 8 is a cloud server.

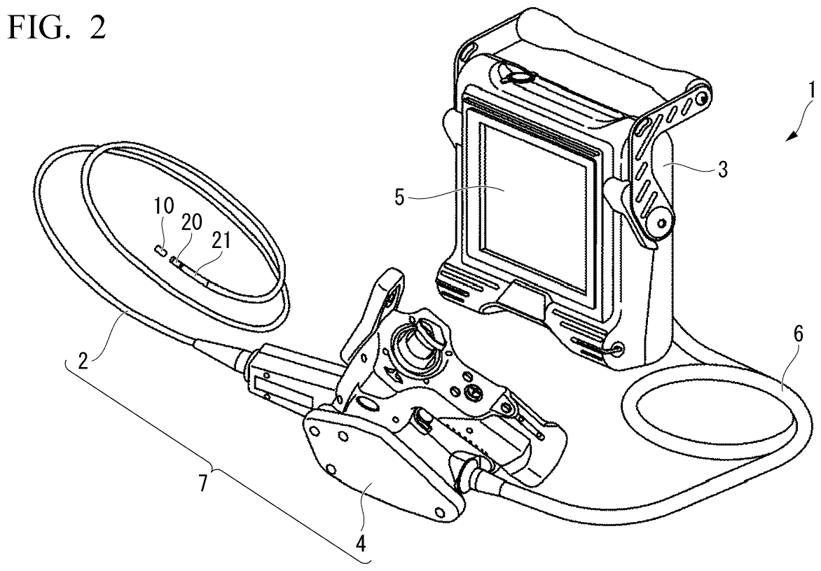

FIG. 2 shows the external appearance of the endoscope device 1. The endoscope device 1 shown in FIG. 2 includes an insertion unit 2, a main body unit 3, an operation unit 4, and a cable 6.

The insertion unit 2 constitutes an endoscope. The insertion unit 2 is inserted into the inside of an inspection target. A distal end portion 20 is disposed at the distal end of the insertion unit 2. The insertion unit 2 is an elongated tube that is bendable from the distal end portion 20 to the proximal end portion. An optical adaptor 10 is attached to the distal end portion 20. A bending portion 21 is disposed on the proximal end side of the distal end portion 20. The bending portion 21 is bendable in a predetermined direction. The proximal end portion of the insertion unit 2 is connected to the operation unit 4.

The operation unit 4 is connected to the main body unit 3 through the cable 6. The operation unit 4 has various buttons including a freeze button and a record button. In addition, the operation unit 4 has various joysticks including a joystick for bending. The operation unit 4 may be installed in a remote control separate from the endoscope device 1. The remote control may perform wired communication or wireless communication with the endoscope device 1.

A user operates the freeze button to input a still image acquisition instruction for acquiring a still image into the endoscope device 1. The user operates the record button to input a still-image-recording instruction for recording the acquired still image into the endoscope device 1. The user operates the joystick for bending to input a bending instruction for bending the bending portion 21 into the endoscope device 1. The user operates the buttons and the like of the operation unit 4 to input various types of information into the endoscope device 1. The operation unit 4 outputs an instruction or information input by the user to the main body unit 3. The insertion unit 2 and the operation unit 4 constitute a scope 7.

A display unit 5 is disposed on the surface of the main body unit 3. The display unit 5 is a monitor (display) such as a liquid crystal display (LCD). The display unit 5 may be a touch panel. In a case in which the display unit 5 is configured as a touch panel, a user touches the screen of the display unit 5 by using a part of his or her body (for example, a finger) or a tool.

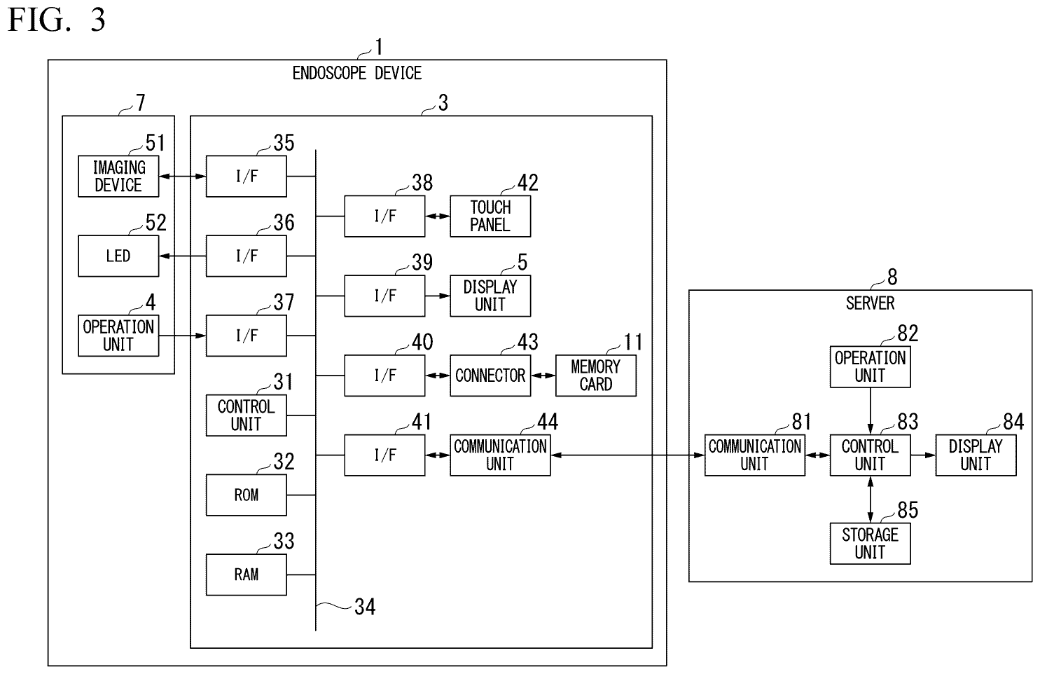

FIG. 3 shows the configuration of the endoscope device 1 and the server 8. The configuration of the scope 7 and the main body unit 3 of the endoscope device 1 is shown in FIG. 3.

The scope 7 has the operation unit 4, an imaging device 51, and an LED 52. The imaging device 51 and the LED 52 are disposed at the distal end portion 20. The imaging device 51 is an image sensor such as a CCD sensor or a CMOS sensor. The imaging device 51 continuously generates two or more images (frames). The two or more images constitute a video. The imaging device 51 outputs each of the generated images to the main body unit 3. In a case in which a still image acquisition instruction is output from the main body unit 3, the imaging device 51 generates a still image and outputs the generated still image to the main body unit 3.

The LED 52 generates illumination light. The illumination light is white light. The illumination light generated by the LED 52 is radiated onto a subject. A light source used in the endoscope device 1 may be replaceable. For example, instead of the LED 52, a light source that generates ultraviolet light or infrared light may be used.

The main body unit 3 constitutes an inspection assistance device. The main body unit 3 has the display unit 5, a memory card 11, a control unit 31, a ROM 32, a RAM 33, I/Fs 35 to 41, a touch panel 42, a connector 43, and a communication unit 44. The control unit 31, the ROM 32, the RAM 33, and the I/Fs 35 to 41 are connected to each other through a bus 34. Each of the I/Fs 35 to 41 is an interface.

The control unit 31 controls each unit of the endoscope device 1. The control unit 31 is constituted by at least one of a processor and a logic circuit. For example, the processor is at least one of a central processing unit (CPU), a digital signal processor (DSP), and a graphics-processing unit (GPU). For example, the logic circuit is at least one of an application-specific integrated circuit (ASIC) and a field-programmable gate array (FPGA). The control unit 31 may include one or a plurality of processors. The control unit 31 may include one or a plurality of logic circuits.

For example, the control unit 31 accepts an instruction or information input by a user through the operation unit 4. When the user operates the freeze button of the operation unit 4, the control unit 31 accepts a still image acquisition instruction and outputs the still image acquisition instruction to the imaging device 51. When the user operates the record button of the operation unit 4, the control unit 31 accepts a still-image-recording instruction and outputs the still-image-recording instruction to the memory card 11.

A user can input a video-recording start instruction or a video-recording end instruction into the endoscope device 1 by operating the button of the operation unit 4. The control unit 31 accepts the video-recording start instruction or the video-recording end instruction. When the video-recording start instruction is accepted, the control unit 31 starts recording the video. When the video-recording end instruction is accepted, the control unit 31 ends recording the video.

The still image or the video acquired during the inspection is recorded in an inspection folder on the memory card 11. An inspection folder is prepared for each inspection target and each inspection portion. A user operates the operation unit 4 or the touch panel 42 to input inspection folder information indicating an inspection folder into the endoscope device 1. By doing so, the user can select the inspection folder in which a still image or a video is recorded. When the user inputs the inspection folder information, the control unit 31 accepts the inspection folder information. Since the inspection folder and the inspection portion are associated with each other, the inspection folder information indicates the inspection portion.

The computer of the endoscope device 1 may read a program and execute the read program. The program includes commands defining the operation of the control unit 31. That is, the functions of the control unit 31 may be realized by software.

The program described above, for example, may be provided by using a “computer-readable recording medium” such as a flash memory. The program may be transmitted from the computer storing the program to the endoscope device 1 through a transmission medium or transmission waves in a transmission medium. The “transmission medium” transmitting the program is a medium having a function of transmitting information. The medium having the function of transmitting information includes a network (communication network) such as the Internet and a communication circuit line (communication line) such as a telephone line. The program described above may realize some of the functions described above. In addition, the program described above may be a differential file (differential program). The functions described above may be realized by a combination of a program that has already been recorded in a computer and a differential program.

The ROM 32 stores the above program. The RAM 33 temporarily stores information and data processed by the control unit 31. The I/F 35 transmits a driving signal to the imaging device 51 and receives an image output from the imaging device 51. The I/F 36 transmits a driving signal to the LED 52.

The I/F 37 receives an instruction or information output from the operation unit 4. The I/F 38 outputs a driving signal to the touch panel 42 and receives a signal output from the touch panel 42. The touch panel 42 is incorporated in the screen of the display unit 5. The I/F 39 outputs an image received by the I/F 35 to the display unit 5. A display unit disposed outside the endoscope device 1 may be used instead of the display unit 5.

The I/F 40 is connected to the memory card 11 through the connector 43. The I/F 40 records the image received by the I/F 35 on the memory card 11 and reads out the image from the memory card 11. In a case in which a still-image-recording instruction is output from the control unit 31, the I/F 40 records the still image on the memory card 11. The memory card 11 is attachable to and detachable from the connector 43.

The I/F 41 is connected to the communication unit 44. The communication unit 44 is a communication device having a communication circuit. For example, the communication unit 44 is a wireless communication device. The communication unit 44 performs communication with the server 8.

The server 8 has a communication unit 81, an operation unit 82, a control unit 83, a display unit 84, and a storage unit 85. The communication unit 81 is a communication device having a communication circuit. For example, the communication unit 81 is a wireless communication device. The communication unit 81 performs communication with the endoscope device 1. The operation unit 82 has buttons and the like.

The control unit 83 controls each unit of the server 8. The control unit 83 is constituted by at least one of a processor and a logic circuit. The control unit 83 may include one or a plurality of processors. The control unit 83 may include one or a plurality of logic circuits.

The computer of the server 8 may read a program and execute the read program. The program includes commands defining the operation of the control unit 83. That is, the functions of the control unit 83 may be realized by software. The program may be realized in the same way as the program that realizes the functions of the control unit 83.

The display unit 84 is a monitor (display) such as an LCD. The display unit 84 may be a touch panel.

The storage unit 85 is a non-volatile storage medium. For example, the storage unit 85 is at least one of a static random access memory (SRAM), an erasable programmable read-only memory (EPROM), an electrically erasable programmable read-only memory (EEPROM), and a flash memory.

The storage unit 85 stores an inspection protocol. The inspection protocol includes a full inspection manual, a partial inspection manual, inspection requirement information, and an inspection folder. The inspection protocol is associated with information indicating an inspection target.

The full inspection manual indicates a portion that needs to be inspected in the inspection target and also indicates an inspection procedure for the portion. The partial inspection manual includes an image of each inspection portion. For example, the partial inspection manual includes a past image, an evaluation standard image, and a reference image. The past image is an image of each inspection portion in an inspection performed in the past. The evaluation standard image is an image showing a flaw or the like indicating the evaluation standard for pass/fail in the inspection. The reference image is an image showing the inspection procedure. In a case in which the inspection target includes two or more inspection portions, the inspection protocol includes two or more partial inspection manuals. The inspection protocol may include information indicating the inspection procedure other than the inspection manual.

The inspection requirement information indicates an inspection requirement that is determined in advance for each inspection target. Normally, the inspection requirement indicates standards for determining whether there is a problem with the inspection target and is determined in advance by each business operator in accordance with various aspects such as the type, age, and usage of the inspection target. The inspection protocol may include two or more pieces of inspection requirement information. In a case in which the inspection target includes two or more inspection portions, the inspection requirement information may indicate an inspection requirement that is determined in advance for each inspection portion.

In a case in which the inspection target includes two or more inspection portions, the inspection protocol includes two or more inspection folders. The inspection folder may be independent of the inspection protocol.

The inspection device in the first embodiment may include the endoscope device 1 and an auxiliary device. For example, the auxiliary device is an image storage device. The image storage device is a mobile device such as a tablet terminal, a smartphone, or a laptop. The image storage device stores a still image or a video generated by the endoscope device 1. The auxiliary device may be a turning tool that rotates a rotating body in the inspection of the inspection target including the rotating body. The auxiliary device may be a guide head attached to the distal end portion 20 in order to facilitate the insertion of the insertion unit 2 into a pipe or the like.

The control unit 31 may acquire position information indicating a position (inspection position) at which the inspection is performed. A method of acquiring the position information will be described. The control unit 31 is connected to the auxiliary device by using the communication unit 44. The auxiliary device is a tablet terminal or the like and has a global positioning system (GPS) receiver that outputs position information. The auxiliary device may receive position information provided in a mobile network. The control unit 31 receives the position information from the auxiliary device by using the communication unit 44. In a case in which the distal end portion 20 has an acceleration sensor, the control unit 31 may generate position information indicating the position of the distal end portion 20 based on information output from the acceleration sensor.

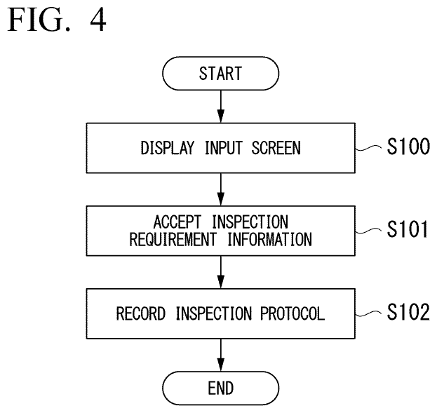

Inspection-requirement-setting processing executed by the server 8 in order to set inspection requirement information will be described by referring to FIG. 4. FIG. 4 shows a procedure of the inspection-requirement-setting processing.

An administrator who manages the implementation of the inspection operates the operation unit 82 to set the inspection requirement information. The administrator is different from an inspector who performs inspection. It is assumed that the administrator is skilled in the inspection and correctly sets the inspection requirement information.

The administrator operates the operation unit 82 to input an instruction to start setting of the inspection requirement information to the server 8. The administrator inputs the instruction in accordance with an inspection requirement determined in advance. At this time, the control unit 83 displays an input screen on the display unit 84 by controlling the display unit 84 (step S100).

After the input screen is displayed, the administrator operates the operation unit 82 to input the inspection requirement information into the endoscope device 1. The inspection requirement information is output from the operation unit 82 and input to the control unit 83. The control unit 83 accepts the inspection requirement information (step S101).

After step S101, the control unit 83 records an inspection protocol including the full inspection manual, the partial inspection manual, the inspection requirement information, and the inspection folder on the storage unit 85 (step S102).

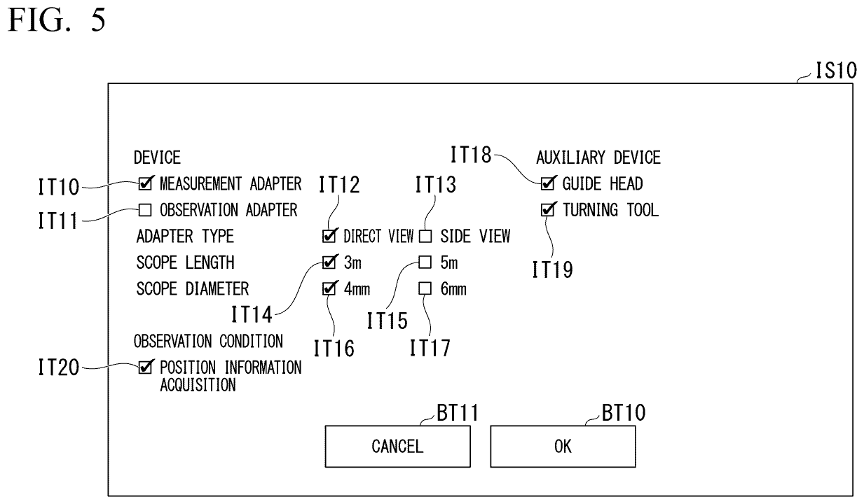

FIG. 5 shows an example of an input screen displayed on the display unit 84. The display unit 84 displays an input screen IS10 shown in FIG. 5.

In a case in which a measurement adapter that is the optical adaptor 10 for measurement is used, the administrator designates an item IT10 on the input screen IS10. At this time, the control unit 83 accepts the inspection requirement information indicating that the measurement adapter is to be used. In a case in which the observation adapter that is the optical adaptor 10 for observation is used, the administrator designates an item IT11 on the input screen IS10. At this time, the control unit 83 accepts inspection requirement information indicating the observation adapter is to be used.

The administrator can designate a direct-view adapter or a side-view adapter as the type of optical adaptor 10. The direct-view adapter is an optical adaptor for observing a subject in a direction parallel to the longitudinal direction of the insertion unit 2. The side-view adapter is an optical adaptor for observing a subject in a direction perpendicular to the longitudinal direction of the insertion unit 2.

In a case in which the direct-view adapter is used, the administrator designates an item IT12 on the input screen IS10. In this case, the control unit 83 accepts the inspection requirement information indicating that the direct-view adapter is to be used. In a case in which the side-view adapter is used, the administrator designates an item IT13 on the input screen IS10. In this case, the control unit 83 accepts the inspection requirement information indicating that the side-view adapter is to be used.

For example, in a case in which the direct-view type measurement adapter is used, the administrator designates the item IT10 and the item IT12. In a case in which the side-view type observation adapter is used, the administrator designates the item IT11 and the item IT13. The administrator may omit the designation of the item IT12 and the item IT13.

The administrator designates information related to the insertion unit 2. Specifically, the administrator designates an item IT14 or an item IT15. The item IT14 indicates that the length of the insertion unit 2 is 3 m. The item IT15 indicates that the length of the insertion unit 2 is 5 m. At this time, the control unit 83 accepts the inspection requirement information indicating the length of the insertion unit 2. In addition, the administrator designates an item IT16 or an item IT17. The item IT16 indicates that the diameter of the insertion unit 2 is 4 mm. The item IT17 indicates that the diameter of the insertion unit 2 is 6 mm. At this time, the control unit 83 accepts the inspection requirement information indicating the diameter of the insertion unit 2.

In a case in which the guide head is used, the administrator designates an item IT18 on the input screen IS10. In this case, the control unit 83 accepts the inspection requirement information indicating that the guide head is to be used.

In the inspection of rotor blades of a turbine that is an inspection target, a turning tool that is an auxiliary device is used. The turning tool is connected to the endoscope device 1 and a rotating shaft of a turbine. The turning tool is capable of communicating with the endoscope device 1. A large number of rotor blades are disposed on the circumference of the turbine's disk. The turning tool rotates the disk based on control information transmitted from the endoscope device 1. In a case in which the turning tool is used, the administrator designates an item IT19 on the input screen IS10. At this time, the control unit 83 accepts the inspection requirement information indicating that the turning tool is to be used.

In a case in which inspection for which position information is required to be recorded is performed, the administrator designates an item IT20 on the input screen IS10. At this time, the control unit 83 accepts the inspection requirement information indicating that the position information is required to be acquired. The position information indicates the position at which the inspection is performed, that is, indicates the position of the inspection target. The position information may indicate the position of the distal end portion 20. In the inspection for which the position information is required to be recorded, the position information is recorded in a still image or a video as exchangeable image file format (Exif) information.

After the designation of necessary items is completed, the administrator presses a button BT10. In a case in which the designation of all items is to be cancelled, the administrator presses a button BT11. The control unit 83 accepts information indicating that the button BT10 or the button BT11 has been pressed. When the information indicating that the button BT10 has been pressed is accepted, the control unit 83 records an inspection protocol including the inspection requirement information for each item on the storage unit 85.

The inspection requirement information may indicate that an inspection folder needs to be set. The inspection requirement information may indicate the brightness of the LED 52 required for the inspection. The inspection requirement information may indicate the storage capacity required for the image storage device. The inspection requirement information may indicate the type of light source required for inspection. The inspection requirement information may indicate information about an inspector. For example, the information about an inspector is configured as information about an account used by the inspector to log in to the system of the endoscope device 1.

The inspection requirement information may indicate the type of inspection device. The inspection device other than the endoscope device 1 is a non-destructive testing device represented by a PTZ camera, an eddy current inspection device, an ultrasonic inspection device, an X-ray inspection device, or the like. The inspection requirement information may indicate identification information for a specific type of inspection device. For example, the identification information is a model name or a model number.

The inspection requirement information may indicate that it is necessary to confirm the accuracy of measurement. In order to confirm the accuracy of measurement, an inspector inserts the distal end portion 20 to which the optical adaptor 10 is attached into a dedicated inspection tool. In this state, the measurement function is executed, and the inspector confirms the measurement result. If the measurement result indicating a predetermined value is obtained, the inspector determines that the accuracy of measurement is sufficient. If the measurement result indicating a predetermined value is not obtained, the inspector determines that the accuracy of measurement is not sufficient. In a case in which the optical adaptor 10 is not properly attached to the distal end portion 20, sufficient accuracy of measurement is not obtained. Therefore, the inspector needs to confirm the state of the optical adaptor 10.

The endoscope device 1 may execute the inspection-requirement-setting processing. The inspection protocol generated in the inspection-requirement-setting processing may be recorded on the memory card 11.

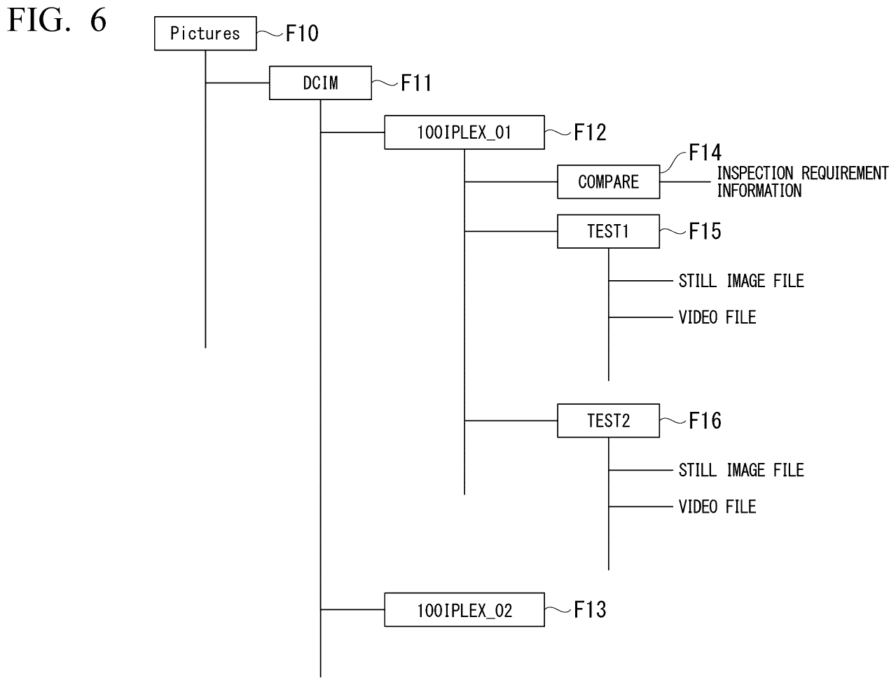

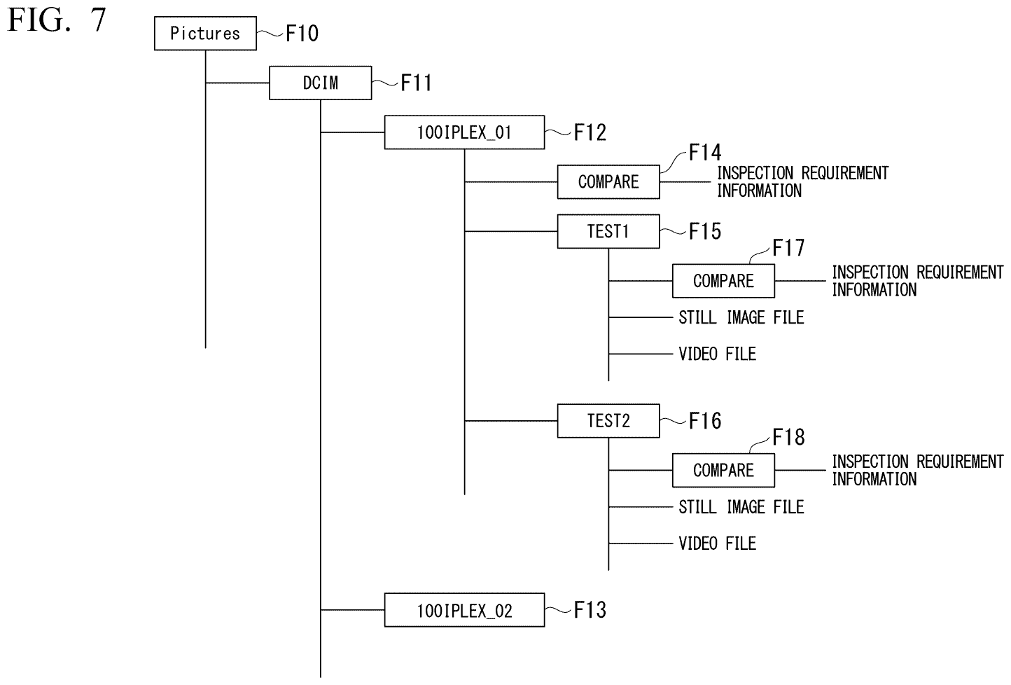

FIGS. 6 and 7 show examples of the structures of inspection folders. In FIGS. 6 and 7, each inspection folder and files contained in the inspection folder are shown schematically.

FIG. 6 shows a first example of the structure of the inspection folder. A “Pictures” folder F10 is generated. A “DCIM” folder F11 is located under the “Pictures” folder F10, and a “100IPLEX_01” folder F12 and a “100IPLEX_02” folder F13 are located under the “DCIM” folder F11.

A “COMPARE” folder F14, a “TEST1” folder F15, and a “TEST2” folder F16 are located under the “100IPLEX_01” folder F12. A file containing the inspection requirement information is stored in the “COMPARE” folder F14. The inspection requirement information is used in common in the inspection of the first inspection portion associated with the “TEST1” folder F15 and the inspection of the second inspection portion associated with the “TEST2” folder F16. A still image file and a video file are stored in each of the “TEST1” folder F15 and the “TEST2” folder F16.

FIG. 7 shows a second example of the structure of the inspection folder. The difference from the first example shown in FIG. 6 will be described below. In addition to the “COMPARE” folder F14 located under the “100IPLEX_01” folder F12, a “COMPARE” folder F17 and a “COMPARE” folder F18 are located. The “COMPARE” folder F17 is located under the “TEST1” folder F15. The “COMPARE” folder F18 is located under the “TEST2” folder F16.

The inspection requirement information for the entire inspection target is stored in the “COMPARE” folder F14. The inspection requirement information for the inspection of the first inspection portion associated with the “TEST1” folder F15 is stored in the “COMPARE” folder F17. The inspection requirement information for the inspection of the second inspection portion associated with the “TEST2” folder F16 is stored in the “COMPARE” folder F18.

A method of setting or changing an inspection folder in the endoscope device 1 will be described below. Hereinafter, an example in which an inspector operates the touch panel 42 will be described. The inspector may operate the operation unit 4 instead ofthe touch panel 42.

In an initial state, no inspection folder is set. When the endoscope device 1 receives the inspection folder from the server 8, the inspection folder is set on the memory card 11.

After the inspection folder is set, the inspector can change the inspection folder. The inspector operates the touch panel 42 and inputs inspection folder information indicating an inspection folder (second inspection folder) different from the currently set inspection folder (first inspection folder) into the endoscope device 1. The I/F 38 outputs the input inspection folder information to the control unit 31. The control unit 31 accepts the inspection folder information.

When the inspection folder information is accepted, the control unit 31 determines that an instruction to change the inspection folder has been issued. When the inspection folder information is not accepted, the control unit 31 determines that an instruction to change the inspection folder has not been issued.

When an instruction to change the inspection folder is issued, the control unit 31 changes the inspection folder currently set on the memory card 11 to the inspection folder indicated by the inspection folder information output from the I/F 38. When an instruction to change the inspection folder is not issued, the control unit 31 continues to monitor the information output from the I/F 38.

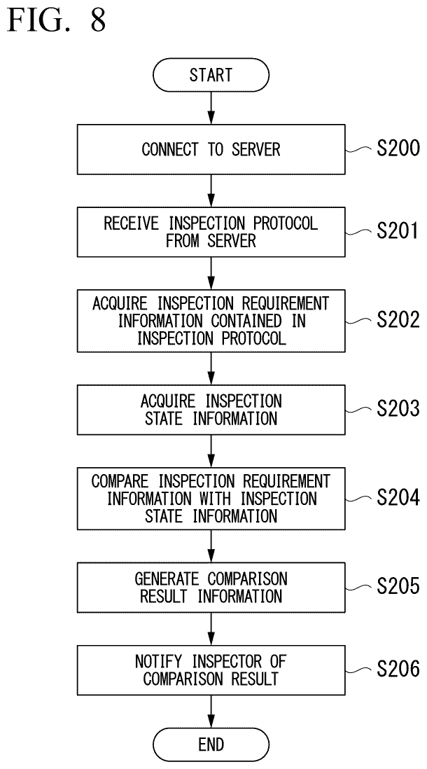

Inspection assistance processing executed by the endoscope device 1 to assist inspection will be described with reference to FIG. 8. FIG. 8 shows a procedure of the inspection assistance processing.

The imaging device 51 continuously generates images (frames). The control unit 31 outputs the images generated by the imaging device 51 to the display unit 5 through the I/F 39. The display unit 5 displays live images of a subject by continuously displaying the images. The processing for generating and displaying an image of the subject is executed in parallel with the processing shown in FIG. 8.

The control unit 31 connects to the server 8 by using the communication unit 44 (step S200).

After step S200, the control unit 31 receives an inspection protocol associated with an inspection target from the server 8 by using the communication unit 44. The control unit 31 records the received inspection protocol on the memory card 11 (step S201).

The inspection protocol includes a full inspection manual and a partial inspection manual. In addition, the inspection protocol includes one or more inspection folders associated with one or more inspection portions and includes one or more “COMPARE” folders. As described above, the “COMPARE” folder includes the inspection requirement information.

For example, an administrator operates the operation unit 82 of the server 8 and inputs information for designating an inspection target into the server 8. The control unit 83 acquires an inspection protocol associated with the information from the storage unit 85. Alternatively, the inspector operates the operation unit 4 of the endoscope device 1 and inputs information for designating the inspection target into the endoscope device 1. The control unit 31 transmits the information to the server 8 by using the communication unit 44. The control unit 83 of the server 8 receives the information from the endoscope device 1 by using the communication unit 81. The control unit 83 acquires an inspection protocol associated with the information from the storage unit 85. The inspection protocol acquired from the storage unit 85 is transmitted from the server 8 to the endoscope device 1 in step S201.

After step S201, the control unit 31 acquires inspection requirement information from the inspection protocol. When the inspection protocol includes two or more pieces of inspection requirement information, the control unit 31 acquires the two or more pieces of inspection requirement information (step S202).

In the first example shown in FIG. 6, when the “100IPLEX_01” folder F12 is set as the inspection folder, the control unit 31 acquires the inspection requirement information stored in the “COMPARE” folder F14 located under the “100IPLEX_01” folder F12. In the first example, when the “TEST1” folder F15 or the “TEST2” folder F16 is set as the inspection folder, the control unit 31 acquires the inspection requirement information stored in the “COMPARE” folder F14 located above the “TEST1” folder F15 or the “TEST2” folder F16.

In the second example shown in FIG. 7, when the “100IPLEX_01” folder F12 is set as the inspection folder, the control unit 31 acquires the inspection requirement information stored in the “COMPARE” folder F14 located under the “100IPLEX_01” folder F12. In the second example, when the “TEST1” folder F15 is set as the inspection folder, the control unit 31 acquires the inspection requirement information stored in the “COMPARE” folder F17 located under the “TEST1” folder F15. In the second example, when the “TEST2” folder F16 is set as the inspection folder, the control unit 31 acquires the inspection requirement information stored in the “COMPARE” folder F18 located under the “TEST2” folder F16.

The control unit 31 may output the inspection requirement information acquired in step S202 to the display unit 5 through the I/F 39. The display unit 5 may notify the inspector of the inspection requirement in advance by displaying the inspection requirement information.

After step S202, the control unit 31 confirms the state of the endoscope device 1 and acquires inspection state information indicating an inspection state. In this case, the control unit 31 acquires inspection state information corresponding to the inspection requirement information (step S203).

When the inspection requirement information indicates that a measurement adapter or an observation adapter is to be used, the control unit 31 confirms the optical adaptor 10 attached to the distal end portion 20 and generates inspection state information indicating the type of optical adaptor 10. The generated inspection state information indicates the measurement adapter or the observation adapter. When the inspection requirement information indicates that a direct-view adapter or a side-view adapter is to be used, the control unit 31 also generates inspection state information indicating the type of optical adaptor 10. The generated inspection state information indicates the direct-view adapter or the side-view adapter in addition to the measurement adapter or the observation adapter. When the optical adaptor 10 is not attached to the distal end portion 20, the inspection state information indicates that the optical adaptor 10 is not attached to the distal end portion 20.

For example, the optical adaptor 10 has a resistor having a resistance value set for each type of optical adaptor 10. When the optical adaptor 10 is attached to the distal end portion 20, the optical adaptor 10 is electrically connected to the endoscope device 1. The control unit 31 generates inspection state information corresponding to the resistance value of the resistor. The resistance value and the type of optical adaptor 10 are associated with each other in advance.

For example, before the inspection of the inspection portion is performed, the control unit 31 generates inspection state information indicating the type of optical adaptor 10. Specifically, when the inspection folder is set or changed, the control unit 31 generates the inspection state information.

When the inspection requirement information indicates the length of the insertion unit 2, the control unit 31 confirms the length of the insertion unit 2 and generates inspection state information indicating the length of the insertion unit 2. When the inspection requirement information indicates the diameter of the insertion unit 2, the control unit 31 confirms the diameter of the insertion unit 2 and generates inspection state information indicating the diameter of the insertion unit 2. For example, when the inspection folder is set or changed, the control unit 31 generates the inspection state information.

For example, the insertion unit 2 has a resistor having a resistance value set for each type of insertion unit 2. The control unit 31 generates inspection state information corresponding to the resistance value of the resistor. The resistance value and the type of insertion unit 2 are associated with each other in advance. The length and diameter of the insertion unit 2 are determined in advance for each type of insertion unit 2.

When the inspection requirement information indicates that a guide head is to be used, the control unit 31 confirms whether the guide head is attached to the distal end portion 20 and generates inspection state information indicating that the guide head is attached. For example, the distal end portion 20 has a sensor for detecting the guide head. The control unit 31 generates inspection state information based on information output from the sensor. For example, when the inspection folder is set or changed, the control unit 31 generates the inspection state information.

When the inspection requirement information indicates that a turning tool is to be used, the control unit 31 confirms whether the turning tool is connected to the endoscope device 1 and generates inspection state information indicating whether the turning tool is connected. For example, when the inspection folder is set or changed, the control unit 31 generates the inspection state information.

When the inspection requirement information indicates that it is necessary to acquire position information, the control unit 31 confirms the settings of the operating system (OS) and generates inspection state information indicating whether the main body unit 3 is capable of acquiring the position information. Alternatively, the control unit 31 confirms the application settings regarding permission to access the position information and generates inspection state information indicating whether the main body unit 3 is capable of acquiring the position information.

For example, when the inspection is performed, the control unit 31 generates the inspection state information. Specifically, when a still image acquisition instruction or a video-recording start instruction is accepted, the control unit 31 generates the inspection state information. Before the inspection is started, the control unit 31 may generate the inspection state information. Specifically, when the inspection folder is set or changed, the control unit 31 may generate the inspection state information.

When the inspection requirement information indicates that an inspection folder needs to be set, the control unit 31 confirms the state of the inspection folder on the memory card 11 and generates inspection state information indicating whether the inspection folder has been set. The control unit 31 may receive the inspection folder and the inspection requirement information separately from the server 8. In a case in which the inspection requirement information has been received but the inspection folder has not been received, the control unit 31 may detect that the inspection folder has not been received and generates inspection state information indicating that the inspection folder has not been set.

When the inspection requirement information indicates the brightness of the LED 52 required for the inspection, the control unit 31 confirms the brightness of the LED 52 and generates inspection state information indicating the brightness. When the inspection requirement information indicates a storage capacity required for the image storage device, the control unit 31 confirms the storage capacity of the image storage device and generates inspection state information indicating the storage capacity. For example, when the inspection folder is set or changed, the control unit 31 generates the inspection state information.

When the inspection requirement information indicates the type of light source required for the inspection, the control unit 31 confirms the type of light source disposed in the distal end portion 20 and generates inspection state information indicating the type. For example, when the inspection folder is set or changed, the control unit 31 generates the inspection state information.

For example, the light source disposed in the distal end portion 20 has a resistor having a resistance value set for each type of light source. The control unit 31 generates inspection state information corresponding to the resistance value of the resistor. The resistance value and the type of light source are associated with each other in advance.

When the inspection requirement information indicates information about the inspector, the control unit 31 confirms the information about the inspector who has logged in to the system of the endoscope device 1 and generates inspection state information indicating the information. When the inspection requirement information indicates the type of inspection device, the control unit 31 confirms the type of inspection device and generates inspection state information indicating the type. When the inspection requirement information indicates identification information for a specific type of inspection device, the control unit 31 confirms the identification information for the inspection device and generates inspection state information indicating the identification information. For example, when the inspection folder is set or changed, the control unit 31 generates the inspection state information.

When the inspection requirement information indicates that the accuracy of measurement needs to be confirmed, the control unit 31 confirms whether an image used to confirm the accuracy of measurement is recorded on the memory card 11 and generates the inspection state information. The inspection state information indicates whether the image used to confirm the accuracy of measurement is recorded on the memory card 11. For example, when the inspection folder is set or changed, the control unit 31 generates the inspection state information.

In an example in which the control unit 31 generates the inspection state information before the inspection is performed, the control unit 31 may generate the inspection state information when the inspection protocol is received from the server 8. Alternatively, when the control unit 31 detects that the optical adaptor 10 is attached to the distal end portion 20, the control unit 31 may generate the inspection state information.

After step S203, the control unit 31 compares the inspection requirement information acquired in step S202 with the inspection state information generated in step S203 and determines whether the inspection state satisfies the inspection requirements (step S204).

When the inspection requirement information indicates that the measurement adapter is to be used, the control unit 31 makes a determination as follows. The inspection state information indicates the type of optical adaptor 10. When the type of optical adaptor 10 is a measurement adapter, the control unit 31 determines that the inspection state satisfies the inspection requirements. When the type of optical adaptor 10 is an observation adapter, the control unit 31 determines that the inspection state does not satisfy the inspection requirements.

When the inspection requirement information indicates that the observation adapter is to be used, the control unit 31 makes a determination as follows. The inspection state information indicates the type of optical adaptor 10. When the type of optical adaptor 10 is an observation adapter, the control unit 31 determines the inspection state satisfies the inspection requirements. When the type of optical adaptor 10 is a measurement adapter, the control unit 31 determines that the inspection state does not satisfy the inspection requirements.

When the inspection requirement information indicates that a direct-view adapter is to be used, the control unit 31 makes a determination as follows. The inspection state information indicates the type of optical adaptor 10. When the type of optical adaptor 10 is a direct-view adapter, the control unit 31 determines that the inspection state satisfies the inspection requirements. When the type of optical adaptor 10 is a side-view adapter, the control unit 31 determines that the inspection state does not satisfy the inspection requirements.

When the inspection requirement information indicates that a side-view adapter is to be used, the control unit 31 makes a determination as follows. The inspection state information indicates the type of optical adaptor 10. When the type of optical adaptor 10 is a side-view adapter, the control unit 31 determines that the inspection state satisfies the inspection requirements. When the type of optical adaptor 10 is a direct-view adapter, the control unit 31 determines that the inspection state does not satisfy the inspection requirements.

When the inspection state information indicates that the optical adaptor 10 is not attached to the distal end portion 20, the control unit 31 determines that the inspection state does not satisfy the inspection requirements.

When the inspection requirement information indicates the length of the insertion unit 2, the control unit 31 makes a determination as follows. The inspection state information indicates the length of the insertion unit 2. When the length indicated by the inspection requirement information and the length indicated by the inspection state information are the same, the control unit 31 determines that the inspection state satisfies the inspection requirements. When the length indicated by the inspection requirement information and the length indicated by the inspection state information are different from each other, the control unit 31 determines that the inspection state does not satisfy the inspection requirements.

When the inspection requirement information indicates the diameter of the insertion unit 2, the control unit 31 makes a determination as follows. The inspection state information indicates the diameter of the insertion unit 2. When the diameter indicated by the inspection requirement information and the diameter indicated by the inspection state information are the same, the control unit 31 determines that the inspection state satisfies the inspection requirements. The diameter indicated by the inspection requirement information and the diameter indicated by the inspection state information are different from each other, the control unit 31 determines that the inspection state does not satisfy the inspection requirements.

When the inspection requirement information indicates that a guide head is to be used, the control unit 31 makes a determination as follows. The inspection state information indicates whether the guide head is attached. When the inspection state information indicates that the guide head is attached, the control unit 31 determines that the inspection state satisfies the inspection requirements. When the inspection state information indicates that the guide head is not attached, the control unit 31 determines that the inspection state does not satisfy the inspection requirements.

When the inspection requirement information indicates that a turning tool is to be used, the control unit 31 makes a determination as follows. The inspection state information indicates whether the turning tool is connected. When the inspection state information indicates that the turning tool is connected, the control unit 31 determines that the inspection state satisfies the inspection requirements. When the inspection state information indicates that the turning tool is not connected, the control unit 31 determines that the inspection state does not satisfy the inspection requirements.

When the inspection requirement information indicates that position information needs to be acquired, the control unit 31 makes a determination as follows. The inspection state information indicates whether the main body unit 3 is capable of acquiring the position information. When the inspection state information indicates that the main body unit 3 is capable of acquiring the position information, the control unit 31 determines that the inspection state satisfies the inspection requirements. When the inspection state information indicates that the main body unit 3 is not capable of acquiring the position information, the control unit 31 determines that the inspection state does not satisfy the inspection requirements.

When the inspection requirement information indicates that an inspection folder needs to be set, the control unit 31 makes a determination as follows. The inspection state information indicates whether the inspection folder is set. When the inspection state information indicates that the inspection folder is set, the control unit 31 determines that the inspection state satisfies the inspection requirements. When the inspection state information indicates that the inspection folder is not set, the control unit 31 determines the inspection state does not satisfy the inspection requirements.

When the inspection requirement information indicates the brightness of the LED 52 required for the inspection, the control unit 31 makes a determination as follows. The inspection state information indicates the brightness of the LED 52. When the brightness indicated by the inspection state information exceeds the brightness indicated by the inspection requirement information, the control unit 31 determines that the inspection state satisfies the inspection requirements. When the brightness indicated by the inspection state information does not exceed the brightness indicated by the inspection requirement information, the control unit 31 determines that the inspection state does not satisfy the inspection requirements.

When the inspection requirement information indicates the storage capacity required for the image storage device, the control unit 31 makes a determination as follows. The inspection state information indicates the storage capacity of the image storage device. When the storage capacity indicated by the inspection state information is larger than the storage capacity indicated by the inspection requirement information, the control unit 31 determines that the inspection state satisfies the inspection requirements. When the storage capacity indicated by the inspection state information is smaller than the storage capacity indicated by the inspection requirement information, the control unit 31 determines that the inspection state does not satisfy the inspection requirements.

When the inspection requirement information indicates the type of light source required for the inspection, the control unit 31 makes a determination as follows. The inspection state information indicates the type of light source disposed in the distal end portion 20. When the type indicated by the inspection state information is the same as the type indicated by the inspection requirement information, the control unit 31 determines that the inspection state satisfies the inspection requirements. When the type indicated by the inspection state information is different from the type indicated by the inspection requirement information, the control unit 31 determines that the inspection state does not satisfy the inspection requirements.

When the inspection requirement information indicates information about the inspector, the control unit 31 makes a determination as follows. The inspection state information indicates the information about the inspector who has logged in to the system of the endoscope device 1. When the inspector indicated by the inspection state information is the same as the inspector indicated by the inspection requirement information, the control unit 31 determines that the inspection state satisfies the inspection requirements. When the inspector indicated by the inspection state information is different from the inspector indicated by the inspection requirement information, the control unit 31 determines that the inspection state does not satisfy the inspection requirements.

When the inspection requirement information indicates the type of inspection device, the control unit 31 makes a determination as follows. The inspection state information indicates the type of inspection device. When the type indicated by the inspection state information is the same as the type indicated by the inspection requirement information, the control unit 31 determines that the inspection state satisfies the inspection requirements. When the type indicated by the inspection state information is different from the type indicated by the inspection requirement information, the control unit 31 determines that the inspection state does not satisfy the inspection requirements.

When the inspection requirement information indicates identification information for a specific type of inspection device, the control unit 31 makes a determination as follows. The inspection state information indicates the identification information for the inspection device. When the identification information indicated by the inspection state information is the same as the identification information indicated by the inspection requirement information, the control unit 31 determines that the inspection state satisfies the inspection requirements. When the identification information indicated by the inspection state information is different from the identification information indicated by the inspection requirement information, the control unit 31 determines that the inspection state does not satisfy the inspection requirements.

When the inspection requirement information indicates that the accuracy of measurement needs to be confirmed, the control unit 31 makes a determination as follows. The inspection state information indicates whether an image used to confirm the accuracy of measurement is recorded on the memory card 11. When the image is recorded on the memory card 11, the control unit 31 determines that the inspection state satisfies the inspection requirements. When the image is not recorded on the memory card 11, the control unit 31 determines that the inspection state does not satisfy the inspection requirements.

In a case in which the inspection protocol includes two or more pieces of inspection requirement information, the control unit 31 generates inspection state information corresponding to each piece of inspection requirement information in step S203. In step S204, the control unit 31 compares each piece of inspection requirement information with the inspection state information corresponding to the inspection requirement information. The control unit 31 generates comparison result information for each combination of the compared inspection requirement information and inspection state information.

In a case in which the inspection protocol includes two or more pieces of inspection requirement information, all of two or more inspection states indicated by two or more pieces of inspection state information corresponding to the two or more pieces of inspection requirement information satisfy the inspection requirements. Alternatively, all of the two or more inspection states do not satisfy the inspection requirements. Alternatively, some of the two or more inspection states satisfy the inspection requirements and the rest of the two or more inspection states do not satisfy the inspection requirements.

After step S204, the control unit 31 generates comparison result information indicating a comparison result (step S205).

After step S205, the control unit 31 outputs the comparison result information generated in step S205 to the display unit 5 through the I/F 39. The display unit 5 displays the comparison result information. Thereby, the inspector is notified of the comparison result (step S206).

The endoscope device 1 may output the comparison result information to an external device having a display unit. The external device may be a personal computer (PC), a tablet terminal, a smartphone, or the like. The external device may display the comparison result information on a display unit. The endoscope device 1 may transmit an e-mail or the like including the comparison result information to the server 8.

The endoscope device 1 may have a speaker and may output a sound signal corresponding to the comparison result information to a speaker. The speaker may notify the inspector of the comparison result by generating a sound in accordance with the sound signal.

The endoscope device 1 may have a vibration generator and may output a control signal corresponding to the comparison result information to a vibration generator. The vibration generator may notify the inspector of the comparison result by generating vibrations in response with the control signal.

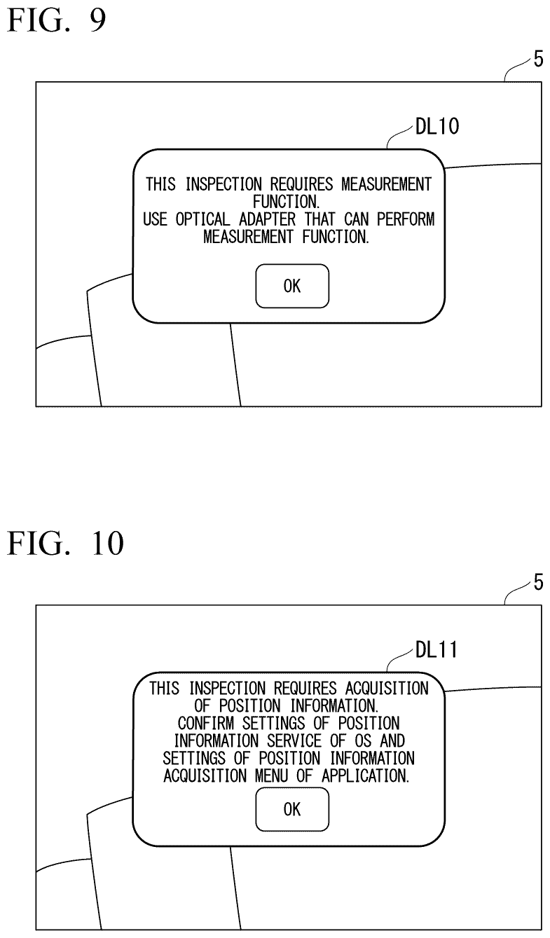

FIG. 9 shows an example of the comparison result information displayed on the display unit 5. The display unit 5 displays a live image and displays a dialog DL10 on the live image. The dialog DL10 corresponds to the comparison result information.

In the example shown in FIG. 9, the inspection requirement information indicates that a measurement adapter is to be used, and the inspection state information indicates that an observation adapter is to be used. The control unit 31 determines that the inspection state does not satisfy the inspection requirements in step S204. The dialog DL10 encourages the inspector to attach the measurement adapter.

FIG. 10 shows another example of the comparison result information displayed on the display unit 5. The display unit 5 displays a live image and displays a dialog DL11 on the live image. The dialog DL11 corresponds to the comparison result information.

In the example shown in FIG. 10, the inspection requirement information indicates that position information needs to be acquired, and the inspection state information indicates that the main body unit 3 is not capable of acquiring the position information. The control unit 31 determines that the inspection state does not satisfy the inspection requirements in step S204. The dialog DL11 encourages the inspector to confirm the settings for acquiring the position information.

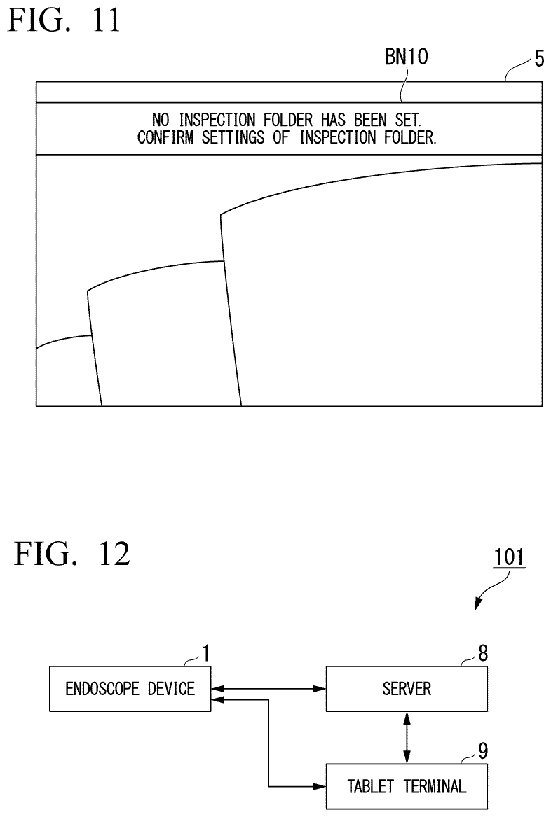

FIG. 11 shows another example of the comparison result information displayed on the display unit 5. The display unit 5 displays a live image and displays a banner BN10 on the live image. The banner BN10 corresponds to the comparison result information.

In the example shown in FIG. 11, the inspection requirement information indicates that an inspection folder needs to be set, and the inspection state information indicates that the inspection folder has not been set. The control unit 31 determines that the inspection state does not satisfy the inspection requirements in step S204. The banner BN10 encourages the inspector to set the inspection folder.

In the examples shown in FIGS. 9, 10, and 11, the comparison result information is superimposed on the live image. The comparison result information and the live image may be displayed so as not to overlap each other.

When the inspection state does not satisfy the inspection requirements, the control unit 31 may notify the inspector of only the comparison result information. The control unit 31 may notify the inspector of additional information in addition to the comparison result information. The additional information may be a correct inspection state. The additional information may be configured as information on a necessary operation. For example, in a case in which the accuracy of measurement has not been confirmed, the additional information may be configured as information on an operation required to confirm the accuracy of measurement.

When some of the two or more inspection states do not satisfy the inspection requirements, the control unit 31 may notify the inspector of only the comparison result information for which it has been determined that the inspection state does not satisfy the inspection requirements. Although the use of a side-view type measurement adapter is required as the inspection requirement, a direct-view type measurement adapter may be attached to the distal end portion 20. In such a case, the control unit 31 may encourage the inspector to change from the direct-view type measurement adapter to the side-view type measurement adapter. Even in such a case, it is possible to perform the measurement. The control unit 31 may encourage the inspector to confirm with a remote advisor whether the optical adaptor 10 needs to be replaced.

When the inspection state satisfies the inspection requirements, the control unit 31 may omit notifying the inspector of the comparison result information. When the inspection state satisfies the inspection requirements, the control unit 31 may notify the inspector of only the comparison result information. The control unit 31 may notify the inspector of additional information in addition to the comparison result information. The additional information may indicate a measurement method recommended for a specific inspection as a recommended requirement. For example, even when the use of a guide head is not required as the inspection requirement, the inspector may be notified of the information encouraging the use of the guide head. The additional information may indicate an optical adaptor that is more appropriate for the inspection than the optical adaptor 10 indicated by the inspection state information.

The control unit 31 may calculate the distance from the distal end portion 20 to a subject by using an image generated by the imaging device 51. As the distance becomes smaller, the accuracy of measurement tends to increase. When the inspection state satisfies the inspection requirements and the distance from the distal end portion 20 to the subject is greater than a predetermined distance, the control unit 31 may encourage the inspector to bring the distal end portion 20 closer to the subject in addition to the comparison result information.

The comparison result information may include the inspection requirement information or the inspection state information. For example, the comparison result information may include inspection requirement information indicating the use of a measurement adapter and may include a comparison result. The comparison result information may include the inspection requirement information and the inspection state information. For example, the comparison result information may include inspection requirement information indicating the use of the measurement adapter, include inspection state information indicating that the measurement adapter is attached to the distal end portion 20, and include the comparison result.

The type of information notified as the comparison result information or the additional information may be changable by the inspector.

Steps S202 to S206 may be executed each time the inspection folder is changed. Alternatively, steps S202 to S206 may be executed each time the inspector logs in to the system of the endoscope device 1. In some cases, two or more inspectors take turns to perform inspection under the same observation conditions. When the observation conditions are changed, the endoscope device 1 can notify the inspector of a change of the observation conditions.

The inspection assistance device (the main body unit 3) according to each aspect of the present invention has the control unit 31. The control unit 31 connects to a storage medium (the storage unit 85) that stores inspection requirement information indicating an inspection requirement determined in advance for each inspection target and acquires the inspection requirement information from the storage medium. The control unit 31 acquires inspection state information indicating an inspection state by confirming the state of an inspection device (the endoscope device 1) used to inspect the inspection target. The control unit 31 compares the inspection requirement information with the inspection state information and generates comparison result information indicating a comparison result. The control unit 31 outputs the comparison result information.

An inspection assistance method according to each aspect of the present invention includes first to sixth steps. In the first step (step S200), the control unit 31 connects to a storage medium (the storage unit 85) that stores inspection requirement information indicating an inspection requirement determined in advance for each inspection target. In the second step (step S201), the control unit 31 acquires the inspection requirement information from the storage medium. In the third step (step S203), the control unit 31 acquires inspection state information indicating an inspection state by confirming the state of an inspection device (the endoscope device 1) used to inspect the inspection target. In the fourth step (step S204), the control unit 31 compares the inspection requirement information with the inspection state information. In the fifth step (step S205), the control unit 31 generates comparison result information indicating a result of comparing the inspection requirement information with the inspection state information. In the sixth step (step S206), the control unit 31 outputs the comparison result information.

A program according to each aspect of the present invention causes a computer to execute the first to sixth steps.

Each aspect of the present invention may include the following modified example. The inspection target includes an inspection portion. When inspection portion information indicating the inspection portion is accepted, the control unit 31 compares the inspection requirement information with the inspection state information.

Each aspect of the present invention may include the following modified example. When a folder associated with the inspection portion is set, the control unit 31 compares the inspection requirement information with the inspection state information.

Each aspect of the present invention may include the following modified example. The inspection target includes a first inspection portion and a second inspection portion. When a first folder associated with the first inspection portion is set and then a second folder associated with the second inspection portion is set instead of the first folder, the control unit 31 compares the inspection requirement information with the inspection state information.

Each aspect of the present invention may include the following modified example. When a user (administrator) designates the inspection requirement information, the inspection requirement information designated by the user is stored on the storage medium (the storage unit 85).

Each aspect of the present invention may include the following modified example. The inspection requirement information indicates that it is necessary to acquire position information indicating a position at which the inspection is to be performed. The control unit 31 acquires information indicating whether the inspection assistance device is capable of acquiring the position information as inspection state information.

Each aspect of the present invention may include the following modified example. The inspection requirement information indicates a state of an instrument used in the inspection device. The control unit 31 acquires device information indicating the state of the instrument as the inspection state information. For example, the instrument is the optical adaptor 10 or the insertion unit 2.

Each aspect of the present invention may include the following modified example. The inspection device includes the endoscope device 1. The endoscope device 1 includes the insertion unit 2 in which the imaging device 51 (image sensor) is disposed at the distal end portion 20.

Each aspect of the present invention may include the following modified example. The inspection requirement information indicates the type of optical adaptor 10 attached to the distal end portion 20. The control unit 31 acquires the device information indicating the type of optical adaptor 10.

Each aspect of the present invention may include the following modified example. The type of optical adaptor 10 corresponds to an optical adaptor (measurement adapter) used when measurement is executed.

Each aspect of the present invention may include the following modified example. The inspection requirement information indicates the type of insertion unit 2. The control unit 31 acquires the device information indicating the type of insertion unit 2.

Each aspect of the present invention may include the following modified example. When the device information is acquired, the control unit 31 compares the inspection requirement information with the inspection state information.

Each aspect of the present invention may include the following modified example. The inspection device includes an auxiliary device connected to the endoscope device 1 or the inspection target.

Each aspect of the present invention may include the following modified example. The storage medium (the storage unit 85) stores two or more pieces of inspection requirement information. The control unit 31 acquires the two or more pieces of inspection requirement information from the storage medium and acquires two or more pieces of inspection state information including the inspection state information. The control unit 31 compares each of the two or more pieces of inspection requirement information with each of the two or more pieces of inspection state information.

Each aspect of the present invention may include the following modified example. The control unit 31 outputs the comparison result information to the display unit 5 (display).

Each aspect of the present invention may include the following modified example. The comparison result information includes the inspection requirement information or the inspection state information.

In the first embodiment, the control unit 31 outputs the comparison result information indicating a result of comparing the inspection requirement information with the inspection state information. Since the inspector is notified of the comparison result information, the endoscope device 1 can assist the execution of inspection in the inspection requirement determined in advance. The endoscope device 1 can prevent an inspection from being performed under incorrect inspection conditions and can make the inspection more efficient without depending on the skill of the inspector.

### Second Embodiment

A second embodiment of the present invention will be described below. The inspection system 100 shown in FIG. 1 is changed to an inspection system 101 shown in FIG. 12. FIG. 12 shows the configuration of the inspection system 101. The inspection system 101 shown in FIG. 12 includes an endoscope device 1, a server 8, and a tablet terminal 9. A PC, a smartphone, or the like may be used instead of the tablet terminal 9.

The endoscope device 1 shown in FIG. 12 is the same as the endoscope device 1 shown in FIG. 1. The server 8 shown in FIG. 12 is the same as the server 8 shown in FIG. 1.

The tablet terminal 9 is an auxiliary device. The endoscope device 1 and the tablet terminal 9 communicate with each other. The server 8 and the tablet terminal 9 communicate with each other.

An inspector operates the tablet terminal 9 and inputs control information for controlling the endoscope device 1 into the tablet terminal 9. The tablet terminal 9 transmits the control information to the endoscope device 1. The endoscope device 1 receives the control information and executes processing in accordance with the control information. In addition, the tablet terminal 9 executes processing similar to the inspection assistance processing shown in FIG. 8.

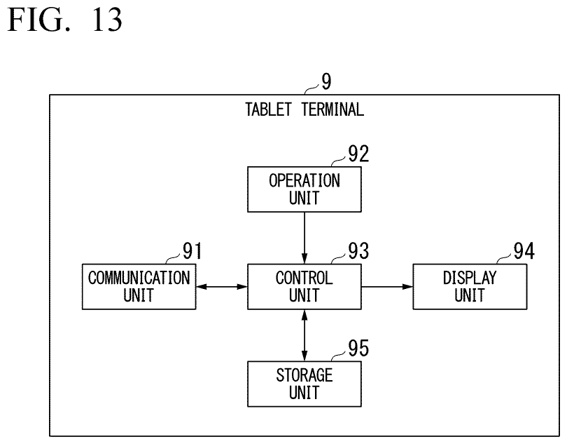

FIG. 13 shows the configuration of the tablet terminal 9. The tablet terminal 9 includes a communication unit 91, an operation unit 92, a control unit 93, a display unit 94, and a storage unit 95. The communication unit 91 is a communication device having a communication circuit. For example, the communication unit 91 is a wireless communication device. The communication unit 91 performs communication with the endoscope device 1 and the server 8. The operation unit 92 has buttons and the like.

The control unit 93 controls each unit of the tablet terminal 9. The control unit 93 is constituted by at least one of a processor and a logic circuit. The control unit 93 may include one or a plurality of processors. The control unit 93 may include one or a plurality of logic circuits.

The computer of the tablet terminal 9 may read a program and execute the read program. The program includes commands that define the operation of the control unit 93. That is, the functions of the control unit 93 may be realized by software. The program may be realized in the same way as the program that realizes the functions of the control unit 93.

The display unit 94 is a monitor (display) such as an LCD. The display unit 94 may be a touch panel.

The storage unit 95 is a non-volatile storage medium. For example, the storage unit 95 is at least one of an SRAM, an EPROM, an EEPROM, and a flash memory. The storage unit 95 stores the inspection protocol received from the server 8.

In the second embodiment, the tablet terminal 9 can assist in performing inspection in the inspection requirement determined in advance.

In all the embodiments and modified examples of the present invention, some or all of the operations performed by the control units 31, 83, and 93 may be consolidated or distributed to one or more control units. In addition, which control unit executes each operation can be appropriately changed.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An inspection assistance device comprising a processor,
wherein the processor is configured to:
connect to a storage medium that stores inspection requirement information indicating an inspection requirement determined in advance for each inspection target;
acquire the inspection requirement information from the storage medium;
acquire inspection state information indicating an inspection state by confirming a state of an inspection device used to inspect the inspection target;
compare the inspection requirement information with the inspection state information;
generate comparison result information indicating a result of comparing the inspection requirement information with the inspection state information; and
output the comparison result information.

2. The inspection assistance device according to claim 1,
wherein the inspection target includes an inspection portion, and
wherein the processor is configured to compare the inspection requirement information with the inspection state information when inspection portion information indicating the inspection portion is accepted.

3. The inspection assistance device according to claim 1,
wherein the inspection target includes an inspection portion, and
wherein the processor is configured to compare the inspection requirement information with the inspection state information when a folder associated with the inspection portion is set.

4. The inspection assistance device according to claim 1,
wherein the inspection target includes a first inspection portion and a second inspection portion, and
wherein the processor is configured to compare the inspection requirement information with the inspection state information when a first folder associated with the first inspection portion is set and then a second folder associated with the second inspection portion is set instead of the first folder.

5. The inspection assistance device according to claim 1,
wherein, when a user designates the inspection requirement information, the inspection requirement information designated by the user is stored on the storage medium.

6. The inspection assistance device according to claim 1,
wherein the inspection requirement information indicates that it is necessary to acquire position information indicating a position at which the inspection is to be performed, and
the processor is configured to acquire information indicating whether the inspection assistance device is capable of acquiring the position information as the inspection state information.

7. The inspection assistance device according to claim 1,
wherein the inspection requirement information indicates a state of an instrument used in the inspection device, and
the processor is configured to acquire device information indicating the state of the instrument as the inspection state information.

8. The inspection assistance device according to claim 7,
wherein the inspection device includes an endoscope device having an insertion unit with an image sensor disposed at a distal end of the insertion unit,
wherein the inspection requirement information indicates a type of optical adaptor attached to the distal end, and
wherein the processor acquires the device information indicating the type of optical adaptor.

9. The inspection assistance device according to claim 8, wherein the type of optical adaptor corresponds to the optical adaptor used when measurement is executed.

10. The inspection assistance device according to claim 7,
wherein the inspection device includes an endoscope device having an insertion unit with an image sensor disposed at a distal end of the insertion unit,
wherein the inspection requirement information indicates a type of insertion unit, and
wherein the processor is configured to acquire the device information indicating the type of insertion unit.

11. The inspection assistance device according to claim 10,
wherein, when the device information is acquired, the processor is configured to compare the inspection requirement information with the inspection state information.

12. The inspection assistance device according to claim 1,
wherein the inspection device includes an endoscope device having an insertion unit with an image sensor disposed at a distal end of the insertion unit.

13. The inspection assistance device according to claim 12,
wherein the inspection device includes an auxiliary device connected to the endoscope device or the inspection target.

14. The inspection assistance device according to claim 1,
wherein the storage medium is configured to store two or more pieces of the inspection requirement information, and
wherein the processor is configured to:
acquire the two or more pieces of the inspection requirement information from the storage medium;
acquire two or more pieces of the inspection state information; and
compare each of the two or more pieces of the inspection requirement information with each of the two or more pieces of the inspection state information.

15. The inspection assistance device according to claim 1,
wherein the processor is configured to output the comparison result information to a display.

16. The inspection assistance device according to claim 15,
wherein the comparison result information includes the inspection requirement information or the inspection state information.

17. An inspection assistance method executed by a processor, the method comprising:
connecting to a storage medium that stores inspection requirement information indicating an inspection requirement determined in advance for each inspection target;
acquiring the inspection requirement information from the storage medium;
acquiring inspection state information indicating an inspection state by confirming a state of an inspection device used to inspect the inspection target;
comparing the inspection requirement information with the inspection state information;
generating comparison result information indicating a result of comparing the inspection requirement information with the inspection state information; and
outputting the comparison result information.

18. A computer readable non-transitory recording medium having a program recorded therein, the program causing a computer to:
connect to a storage medium that stores inspection requirement information indicating an inspection requirement determined in advance for each inspection target;
acquire the inspection requirement information from the storage medium;
acquire inspection state information indicating an inspection state by confirming a state of an inspection device used to inspect the inspection target;
compare the inspection requirement information with the inspection state information;
generate comparison result information indicating a result of comparing the inspection requirement information with the inspection state information; and
output the comparison result information.
